(19) United States
(12) Patent Application Publication
(10) Pub. No.: US 2017/0138270 A1
(43) Pub. Date: May 18, 2017

(54) INSTRUMENTATION ADAPTOR FOR A GAS TURBINE ENGINE

(71) Applicant: United Technologies Corporation, Farmington, CT (US)

(72) Inventors: Russell B. Witlicki, Wethersfield, CT (US); Dwayne E. Messerschmidt, Columbia, CT (US)

(21) Appl. No.: 14/944,690

(22) Filed: Nov. 18, 2015

(51) Int. Cl. F02C 7/28; F02C 3/04; F02C 7/20; F01D 21/00

(52) U.S. Cl. CPC F02C 7/28; F01D 21/003; F02C 3/04; F02C 7/20; F05D 2220/32

(57) ABSTRACT

An instrumentation adaptor for a gas turbine engine includes a seat, a seal contacting a surface of the seat, a follower contacting the seal opposite the seat, a compressive component contacting the follower opposite the seal. The seal is constructed of a crushing seal material. The compressive component includes an exterior facing interface feature. The seal is in a compressed state.

### STATEMENT REGARDING FEDERALLY SPONSORED RESEARCH OR DEVELOPMENT

This invention was made with government support under contract number FA8650-09-D-2923-0021 awarded by the United States Air Force. The government has certain rights in the invention.

### TECHNICAL FIELD

The present disclosure relates generally to instrumentation for gas turbine engine testing, and specifically to an instrumentation adaptor for use in a gas turbine engine during testing.

### BACKGROUND

During the development and testing of gas turbine engines, such as those used in military and commercial aircraft, it is necessary to install instrumentation within pressurized compartments internal to the engine. By way of example, bearing systems and similar compartments within the engine need to be monitored during testing. The instrumentation allows the pressure, temperature, and other parameters within the compartment to be monitored during the engine testing by providing data back to a controller, or other data collection device, via lead wires.

The compartment containing the instrumentation includes a lead wire egress. The lead wire egress configuration must allow the lead wires to exit the pressurized compartment, and must also prevent the leakage of fluids, such as air or oil, from the pressurized compartment. In some examples, the fluids within the pressurized compartment are flammable, or are critical to the engine operation, and leakage of the fluids through the instrumentation egress can disrupt the engine test.

Compartments internal to the test engine, such as bearing compartments, have limited space in which an instrumentation egress, and corresponding seal, can be positioned. As a result, large multi-piece fittings suitable for use on an engine casing may not be possible at the internal compartment. Similarly, space and material constraints can prevent the utilization of welded seals.

### SUMMARY OF THE INVENTION

In one exemplary embodiment an instrumentation adaptor for a gas turbine engine includes a seat, a seal contacting a surface of the seat and being constructed of a crushing seal material, a follower contacting the seal opposite the seat, a compressive component contacting the follower opposite the seal and including an exterior facing interface feature, and wherein the seal is in a compressed state.

In another exemplary embodiment of the above described instrumentation adaptor for a gas turbine engine the exterior facing interface feature includes a threaded exterior surface.

Another exemplary embodiment of any of the above described instrumentation adaptors for a gas turbine further includes an engine a plurality of instrumentation leads passing through the seat, seal, follower and compressive component.

In another exemplary embodiment of any of the above described instrumentation adaptors for a gas turbine engine the seal is crushed against each of the leads in the plurality of instrumentation leads, such that an at least approximately airtight seal exists around each of the leads.

In another exemplary embodiment of any of the above described instrumentation adaptors for a gas turbine engine the compressive component includes a second interface feature configured to connect to a cooled egress tube.

In another exemplary embodiment of any of the above described instrumentation adaptors for a gas turbine engine the interface feature includes a seal.

In another exemplary embodiment of any of the above described instrumentation adaptors for a gas turbine engine each of the seat, follower, and compressive component include at least one lead pass through.

In another exemplary embodiment of any of the above described instrumentation adaptors for a gas turbine engine the at least one lead pass through is sized to loose fit at least one instrumentation lead.

In one exemplary embodiment a gas turbine engine includes a compressor, a combustor fluidly connected to the compressor, a turbine fluidly connected to the combustor, at least one instrumentation egress incorporated in a compartment of the compressor, combustor and turbine; and an instrumentation adaptor incorporated in the at least one instrumentation egress. The instrumentation adaptor includes a compressive component interfaced with an interior surface feature of the instrumentation egress, and a seal maintained in a compressed state via the compressive component.

In another exemplary embodiment of the above described gas turbine engine the compressive component is interfaced with the interior surface feature via a thread on an exterior facing surface of the compressive component and a threading on an inward facing surface of the instrumentation egress.

In another exemplary embodiment of any of the above described gas turbine engines the seal is constructed at least partially via a crushing seal material.

In another exemplary embodiment of any of the above described gas turbine engines the crushing seal material is a flexible graphite material.

Another exemplary embodiment of any of the above described gas turbine engines further includes a cooling tube connected to the instrumentation adaptor, the cooling tube including a lead wire passage.

In another exemplary embodiment of any of the above described gas turbine engines the cooling tube is connected to the instrumentation adaptor via a seal.

In another exemplary embodiment of any of the above described gas turbine engines the instrumentation adaptor includes a seat, the seal contacting a surface of the seat and being constructed of a crushing seal material, a follower contacting the seal opposite the seat, the compressive component contacting the follower opposite the seal and including an exterior facing interface feature, and wherein the seal is in a compressed state.

Another exemplary embodiment of any of the above described gas turbine engines further includes at least one instrumentation sensor positioned within a gas turbine engine compartment, the instrumentation sensor including at least one lead wire, and the at least one lead wire passing through the at least one instrumentation egress.

In another exemplary embodiment of any of the above described gas turbine engines the gas turbine engine compartment is a bearing compartment.

An exemplary method for sealing an instrumentation egress for a test engine includes passing a plurality of lead wires through an instrumentation egress, compressing a seal in the instrumentation egress against a seat via rotation of a compressive component, and maintaining compression of the compressive component via an interface between the compressive component and an inward facing surface of the instrumentation egress.

Another example of the above described exemplary method for sealing an instrumentation egress for a test engine the interface between the compressive component and the inward facing surface of the instrumentation egress is an exterior facing threading of the compressive component and a complimentary inward facing threading of the inward facing surface.

Another example of any of the above described exemplary methods for sealing an instrumentation egress for a test engine, further includes connecting a cooling tube to an output of the instrumentation egress and passing the lead wires through the cooling tube.

These and other features of the present invention can be best understood from the following specification and drawings, the following of which is a brief description.

### BRIEF DESCRIPTION OF THE DRAWINGS

FIG. 1 schematically illustrates an example gas turbine engine.

FIG. 2 schematically illustrates an exemplary instrumentation egress port and instrumentation egress adaptor.

FIG. 2A schematically illustrates an enlarged view of a portion of the instrumentation egress port and instrumentation egress adaptor of FIG. 2.

FIG. 3 schematically illustrates a cooled lead wire tube connected to the configuration of FIG. 2.

### DETAILED DESCRIPTION OF AN EMBODIMENT

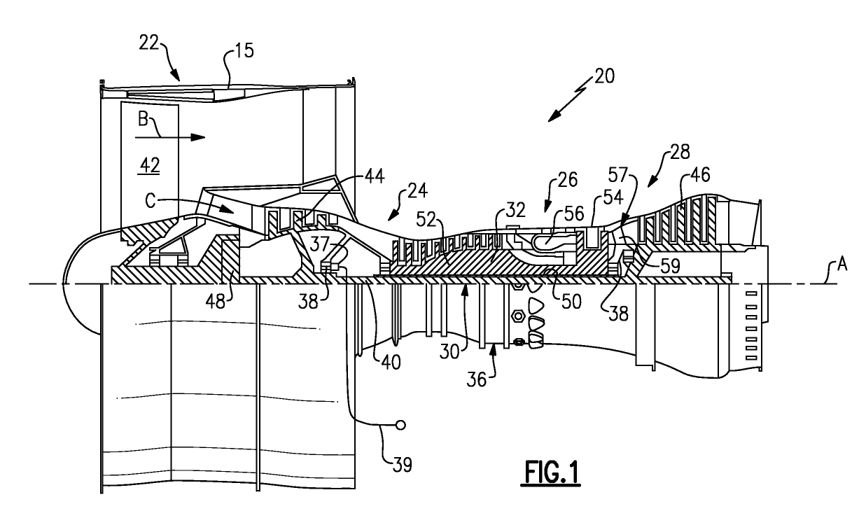

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct defined within a nacelle 15, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

Included within one of the bearing systems 38 is an instrumentation egress 37. One or more lead wires 39 passes through the instrumentation egress 37, allowing a controller, or other data collection device, to connect to one or more sensors (instrumentation devices) within the bearing system 38. During engine testing and validation, the sensors collect information about parameters, such as temperature and pressure, within the compartment. While illustrated as being positioned in a single bearing compartment of a bearing system 38, one of skill in the art will understand that instrumentation, and instrumentation egresses 37, can be installed in any number of bearing compartments in any number of bearing systems 38, or similar compartments, throughout the gas turbine engine 20.

Further, in some exemplary systems, the lead wire 39 passing through the egress is sensitive to heat, such as the heat produced via the operation of a gas turbine engine. In such examples, the lead wire 39 is contained within a cooling tube (illustrated in FIG. 3), and cooled in order to prevent damage. In these examples, the cooling tube is connected to the instrumentation egress 37 via a connection feature.

The low speed spool 30 generally includes an inner shaft 40 that interconnects a fan 42, a first (or low) pressure compressor 44 and a first (or low) pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a second (or high) pressure compressor 52 and a second (or high) pressure turbine 54. A combustor 56 is arranged in exemplary gas turbine 20 between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

During testing and validation of the gas turbine engine 20, the bearing systems 38, and other compartments within the gas turbine engine, are monitored to ensure that temperature, pressure and other parameters in the compartment are maintained within acceptable levels. To achieve this monitoring, the lead wire 39 is connected to instrumentation within the corresponding compartment through the instrumentation egress 37 in one of the walls of the compartment.

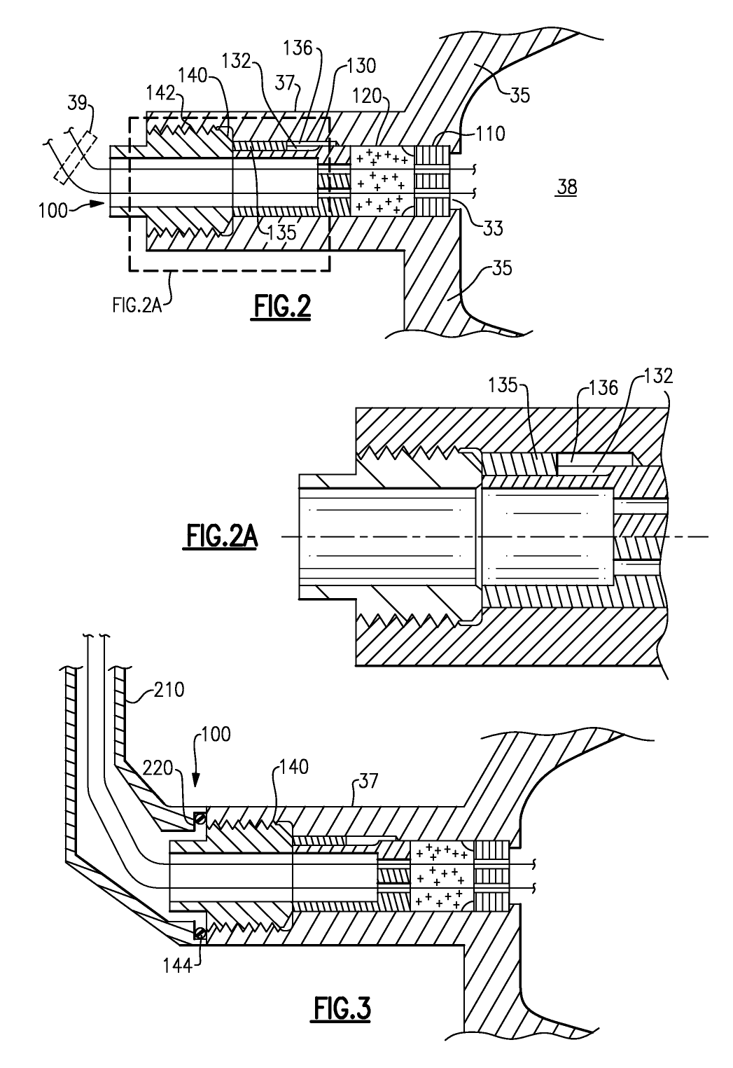

FIG. 2 illustrates an exemplary instrumentation egress 37 including an instrumentation adaptor 100. The instrumentation egress 37 is a portion of the bearing compartment walls 35 that defines an opening 33. The instrumentation egress 37 can be machined, or cast, in a single solid portion of the bearing compartment walls 35, or formed at a joint between multiple bearing compartment walls 35. In alternative examples, other known methods for creating an egress opening can be utilized to the same effect. The instrumentation adaptor 100 contained within the instrumentation egress 37 includes a seat 110, a seal 120, a follower 130, and a nut 140.

Instrumentation lead wires 39 are passed through the adaptor 100 to a controller or other data collection device outside the test engine 20. In the illustrated example, two lead wires 39 are passed through the instrumentation egress 37. Alternate examples can include additional lead wires 39 passing through the same holes in the egress adaptor 100 or through distinct holes arranged in a similar fashion, or a single lead wire 39.

Each of the seat 110, the follower 130 and the nut 140 include one or more holes, referred to as lead pass throughs, through which the lead wires 39 are passed. In one example, the lead pass throughs are sized to loose fit one or more lead wires 39. The seal 120 is constructed of a crushing sealing material and the lead wires 39 are passed through the seal 120. During installation of the adaptor 100, the seal 120 is compressed against the seat 110. The compression of the seal 120 crushes the sealing material against the lead wires 39 and creates an airtight, or approximately airtight, seal around the wires 39. Any suitable crushing seal material can be utilized to form the seal 120. In one example, the seal 120 is a flexible graphite material.

The compression of the seal 120 is achieved by rotation of the nut 140, and can be configured to any desired level of compression. To maintain the nut 140 in position, and maintain the compression of the seal 120, during the engine test, the nut 140 includes threading 142 on one or more exterior surfaces of the nut 140. The threading 142 interfaces with threading on an interior facing surface of the instrumentation egress 37.

In some engines, rotation of the nut 140 can cause a corresponding rotation of the follower 130, the seal 120, and the seat 110. Such a rotation can cause the lead wires 39 to shear. To address this, in some examples the follower 130 includes a pin slot 132 configured to align with a corresponding pin slot 136 in the instrumentation egress 37. FIG. 2A schematically illustrates an enlarged view of a portion of the instrumentation egress port and instrumentation egress adaptor of FIG. 2. A separate pin 135 engages both slots 136, 132 and prevents the follower 130 from rotating along with the nut 140 during installation of the egress adaptor 100. In alternative examples, the pin feature 132 can be replaced with alternate keying techniques to prevent rotation of.

With continued reference to FIGS. 2 and 2A, and with like numerals indicating like elements, FIG. 3 illustrates the instrumentation egress 37 of FIG. 2 with an attached cooling tube 210. Instrumentation within a bearing compartment of a turbine section of a test engine is exposed to extreme temperatures during operation. In some examples, the lead wires 39 are actively cooled in order to prevent damage to the lead wires 39. In order to facilitate cooling the lead wires 39, a cooling tube 210 is connected to the bearing compartment instrumentation egress 37 via a separate bolted connection feature in a way that surrounds the nut 140, and the lead wires 39 are passed through the cooling tube. The attached cooling tube 210 has a groove feature 220, and a sealing feature 144, such as a metal c-seal type seal. In alternate examples, the connection feature can be any connection feature, and the groove feature and sealing feature is not required to seal the joint between the cooling tube and the bearing compartment egress feature 37.

In some examples the cooling tube 210 is actively cooled via injection of cooling fluid, such as air or Gaseous Nitrogen (GN₂), into the interior of the cooling tube 210. In alternative examples, a cooling fluid can be circulated through passages in the walls of the cooling tube 210, and provide a cooling and insulating effect to the interior of the cooling tube 210.

With reference to both FIGS. 2 and 3, the utilization of a nut 140 interfacing with the instrumentation egress 37 allows the nut 140 and the component or components forming the instrumentation egress 37 to be formed of dissimilar metals without impacting the ability to maintain the nut 140, or other instrumentation egress elements, in position. As the nut 140 is interfaced with the instrumentation egress 37 via an interface feature, the interface feature can compensate for dissimilar thermal expansion. This allows more flexibility in the design of the nut 140, and the instrumentation adaptor 100. In contrast, existing welded on instrumentation egress and instrumentation adaptor systems are required to have similar metal types between the egress adaptor and the bearing compartment in order to facilitate the welding process.

While described above within the context of a gas turbine engine, one of skill in the art will understand that any number of similar applications could benefit from the instrumentation adaptor described herein. It is further understood that any of the above described concepts can be used alone or in combination with any or all of the other above described concepts. Although an embodiment of this invention has been disclosed, a worker of ordinary skill in this art would recognize that certain modifications would come within the scope of this invention. For that reason, the following claims should be studied to determine the true scope and content of this invention.

1. An instrumentation adaptor for a gas turbine engine comprising:
a seat;
a seal contacting a surface of the seat and being constructed of a crushing seal material;
a follower contacting said seal opposite said seat;
a compressive component contacting said follower opposite said seal and including an exterior facing interface feature; and
wherein the seal is in a compressed state.

2. The instrumentation adaptor of claim 1, wherein the exterior facing interface feature includes a threaded exterior surface.

3. The instrumentation adaptor of claim 1, further comprising a plurality of instrumentation leads passing through said seat, seal, follower and compressive component.

4. The instrumentation adaptor of claim 3, wherein said seal is crushed against each of said leads in said plurality of instrumentation leads, such that an at least approximately airtight seal exists around each of said leads.

5. The instrumentation adaptor of claim 1, wherein said compressive component includes a second interface feature configured to connect to a cooled egress tube.

6. The instrumentation adaptor of claim 5, wherein the interface feature includes a seal.

7. The instrumentation adaptor of claim 1, wherein each of said seat, follower, and compressive component include at least one lead pass through.

8. The instrumentation adaptor of claim 7, wherein the at least one lead pass through is sized to loose fit at least one instrumentation lead.

9. A gas turbine engine comprising
a compressor;
a combustor fluidly connected to the compressor;
a turbine fluidly connected to the combustor;
at least one instrumentation egress incorporated in a compartment of said compressor, combustor and turbine; and
an instrumentation adaptor incorporated in said at least one instrumentation egress, the instrumentation adaptor including:
a compressive component interfaced with an interior surface feature of the instrumentation egress; and
a seal maintained in a compressed state via said compressive component.

10. The gas turbine engine of claim 9, wherein the compressive component is interfaced with the interior surface feature via a thread on an exterior facing surface of the compressive component and a threading on an inward facing surface of the instrumentation egress.

11. The gas turbine engine of claim 9, wherein the seal is constructed at least partially via a crushing seal material.

12. The gas turbine engine of claim 11, wherein the crushing seal material is a flexible graphite material.

13. The gas turbine engine of claim 9, further comprising a cooling tube connected to said instrumentation adaptor, the cooling tube including a lead wire passage.

14. The gas turbine engine of claim 13, wherein the cooling tube is connected to said instrumentation adaptor via a seal.

15. The gas turbine engine of claim 9, wherein the instrumentation adaptor comprises:
a seat;
the seal contacting a surface of the seat and being constructed of a crushing seal material;
a follower contacting said seal opposite said seat;
the compressive component contacting said follower opposite said seal and including an exterior facing interface feature; and
wherein the seal is in a compressed state.

16. The gas turbine engine of claim 9, further comprising at least one instrumentation sensor positioned within a gas turbine engine compartment, the instrumentation sensor including at least one lead wire, and the at least one lead wire passing through said at least one instrumentation egress.

17. The gas turbine engine of claim 16, wherein the gas turbine engine compartment is a bearing compartment.

18. A method for sealing an instrumentation egress for a test engine comprising:
passing a plurality of lead wires through an instrumentation egress;
compressing a seal in said instrumentation egress against a seat via rotation of a compressive component; and
maintaining compression of said compressive component via an interface between said compressive component and an inward facing surface of said instrumentation egress.

19. The method of claim 18, wherein the interface between said compressive component and said inward facing surface of said instrumentation egress is an exterior facing threading of said compressive component and a complimentary inward facing threading of said inward facing surface.

20. The method of claim 18, further comprising connecting a cooling tube to an output of said instrumentation egress and passing said lead wires through said cooling tube.
